(19) United States
(12) Patent Application Publication
(10) Pub. No.: US 2012/0176041 A1
(43) Pub. Date: Jul. 12, 2012

(54) METHOD OF CONTROLLING LIGHT DISTRIBUTION IN A SPACE INCLUDING MULTIPLE INSTALLED LIGHT SOURCES AND AN EXTERNAL LIGHT SOURCE

(75) Inventor: Dagnachew Birru, Yorktown Heights, NY (US)

(73) Assignee: KONINKLIJKE PHILIPS ELECTRONICS N.V., EINDHOVEN (NL)

(21) Appl. No.: 13/395,505

(22) PCT Filed: Sep. 14, 2010
(86) PCT No.: PCT/IB2010/054125

§ 371 Date: Mar. 12, 2012

Related U.S. Application Data
(60) Provisional application No. 61/242,409, filed on Sep. 15, 2009.

(51) Int. Cl. H05B 37/02

(52) U.S. Cl. 315/151

(57) ABSTRACT

This invention relates to a method and system for controlling light distribution in a space including multiple installed light sources and an external light source. The luminance level of light from said light sources is measured at different measuring areas within the space. A weighed luminance level is determined for each of the measuring areas based on the measured luminance levels, where the weighted luminance level indicates the contribution from the light sources to the measured luminance level at the different measuring areas. This weighed luminance level is used as a tuning parameter for tuning the emitted light at the installed light sources such that the weighed luminance level at each of the different measuring areas substantially matches a pre-defined target luminance level at the different measuring areas.

### FIELD OF THE INVENTION

This invention relates to a method and a system for controlling light distribution in a space including multiple installed light sources and an external light source.

### BACKGROUND OF THE INVENTION

40% of the world's energy is consumed in Buildings: 18% in commercial buildings and 21% in residential buildings. In commercial buildings, 26% is spent only for lighting. However, in commercial buildings, there is ample opportunity to utilize natural light (daylight) in a way to reduce the electric energy used for lights. Such products exit today, called sometimes daylight harvesting. Usually a single sensor and a control system is employed to control light in offices or spaces in buildings. This results in overall non-uniform light distribution. In addition, the light setting will be done to satisfy the darkest part of the office/space, thereby resulting in more electric energy consumption than necessary.

Singhvi et al., Intelligent Light Control Using Sensor Networks, SenSys, ACM, 2005, discloses an intelligent light control using sensor networks, where a tradeoff between fulfilling different occupants light preferences or needs and minimizing consumption is described. According to this references, a use is made of utility functions to satisfy requirements of different users where one photo sensor per user is used plus additional sensor in case of daylight to measure daylight. According to this reference, the optimization of light distribution is solved using search algorithm.

The problem with this reference is that one sensor is being implemented per user meaning that in e.g. a single occupant office having multiple light sources the light distribution cannot be controlled when there is e.g. rapid change in the light from the window in the office (suddenly cloud weather). In such scenarios, there can be a large non-uniformity within the room extending from the window where a first light source could be mounted towards the opposite side in the room where a second light source could be mounted.

The inventor of the present invention has appreciated that an improved light control is of benefit, and has in consequence devised the present invention.

### SUMMARY OF THE INVENTION

The object of the present invention is to provide an improved way of managing and controlling light distribution in spaces such as a single office spaces where there is an external light source such as natural daylight from windows or daylight harvesters present.

According to a first aspect, the present invention relates to a method of controlling light distribution in a space including multiple installed light sources and an external light source, comprising:
measuring the luminance level of light from said light sources at different measuring areas within the space,
determining a weighed luminance level for each of said measuring areas based on the measured luminance levels, the weighted luminance level indicating the contribution from the light sources to the measured luminance level at said different measuring areas, and
utilizing the weighed luminance level as a tuning parameter for tuning the emitted light at the installed light sources such that the weighed luminance level at each of the different measuring areas substantially matches a pre-defined target luminance level at the different measuring areas.

Thus, an adaptive light control method is provided that allows a fully controlled light distribution within the space in accordance within the pre-defined target luminance level so that the light distribution becomes uniform or non uniform, depending on whether the required target luminance level within the space is supposed to be constant or not (e.g. higher light level at one side of the space). Assuming that the external light source is a daylight coming from a window, the luminance level within the space will be automatically tuned until the luminance level within the room substantially matches the luminance level as defined by the pre-defined target luminance level. Accordingly, the method does not only result in a fully controlled light distribution within the space but also in energy savings because the light level at the installed light sources may be tuned in accordance to how the luminance level due to the window changes.

In one embodiment, the step of determining the weighed luminance level comprises:
calculating the difference between the pre-defined target luminance level at said different measuring areas and said measured luminance levels;

\vec{e}(n)=\vec{u}(n)−\vec{y}(n),

where n is a time indicator, \vec{u}(n)=[u₁, . . . , uₖ]^{T} is the pre-defined target luminance level at k different measuring areas and the vector elements u₁, . . . , uₖ indicate the target illumination level at the respective measuring areas and where \vec{y}(n)=[y₁, . . . , yₖ]^{T} is the measured luminance level at the k different measuring areas, and
multiplying the calculated difference \vec{e}(n) with N×k weight factor matrix A with N being the number of installed light sources, where the elements aᵢⱼ of the weight factor matrix A indicates weight of the N installed light sources to the measured luminance level at the different measuring areas. The subscript ‘T’ means simply transposed vector.

In one embodiment, the step of tuning the emitted light at the installed light sources is performed by iteratively adjusting tuning parameters \vec{x}(n) until:

\vec{x}(n)≈\vec{x}(n−1)+μA\vec{e}(n)

is fulfilled, \vec{x}(n) being length N column vector, \vec{x}(n−1) being the tuning parameters previous to \vec{x}(n) and μ being an adaptation step size indicator.

In one embodiment, vector elements u₁, . . . , uₖ are equal target values. In that way, the target luminance level as defined e.g. by a user via e.g. an appropriate computer interface is a single luminance level (i.e. the measure luminance level is supposed to be the same everywhere) so that a constant-uniform light distribution will be obtained within the space in case the vector elements u₁, . . . , uₖ are equal target values.

In another embodiment, the two or more of the vector elements u₁, . . . , uₖ are unequal target values. In that way, the target luminance level contains two or more target luminance level meaning that it is possible to define the target luminance level within the space. This is of particular advantage where e.g. the space a conference room where one side of the room furthest away from the external light source (e.g. window) has a projector and a screen, where it is required that near the projector the light level is low, but higher where the audiences are placed. The uniformity here will be experienced by the person in the space so that he/she will not experience sudden abrupt change in the luminance level between two adjacent light sources although the target luminance levels at the areas where these light sources are placed is different, but the person might experience the light as gradually increasing/decreasing and thus the uniformity will be reflected in such a continuous change instead of an abrupt change.

This could also be implemented in an open space office with a combination of installed light sources and external light sources, where each individual occupant within the space can select the luminance levels of an area of the office space, allocated to an occupant, according to the specific needs or preferences of the occupier of that area. Each area allocated to an occupant could have one or a plurality of installed light sources and one or a plurality of sensors. Uniformity in the light distribution will be obtained within each allocated area of the open space office. The occupants of the open office space will not experience any sudden abrupt changes in luminance levels between two adjacent areas but could experience a gradually increase/decrease of the luminance levels when looking/moving around in the office space. Thus the uniformity will be reflected in a continuous manner instead of abrupt changes. The light distribution could therefore, when being viewed over the whole office space, be described as a state of controlled non-uniformity.

In one embodiment, the weight factor matrix A is a normalized matrix such that the weight factor matrix elements aᵢⱼ of the weight factor matrix are assigned a weight value between 0 and 1.

In one embodiment, the method further comprises detecting presence of a user for given areas within said space, where in case no presence is detected within a given area selected from the areas that the target illumination level at that given area will be reduced. Thus, when the presence of users are not detected for one or more of these areas the target illumination level (vector u) for these one or more areas will be reduced (e.g. down to zero) and in that way more energy will be saved.

According to another aspect, the present invention relates to a computer program product for instructing a processing unit to execute the above mentioned method steps when the product is run on a computer.

According to still another aspect, the present invention relates to a system for controlling light distribution in a space including internal light sources and an external light source, comprising:
sensors for measuring the luminance level of light from said light sources at different measuring areas within the space,
a processor for determining a weighed luminance level for each of said measuring areas based on the measured luminance levels, the weighted luminance level indicating the contribution from the light sources to the measured luminance level at said different measuring areas,
a control unit for utilizing the weighed luminance level as a tuning parameter for tuning the emitted light at the installed light sources such that the weighed luminance level at each of the different measuring areas substantially matches a pre-defined target luminance level at the different measuring areas.

Accordingly, a system is provided that can adaptively control the luminance level within the space in accordance to individual luminance level requirements as defined by the pre-defined target luminance level, which may be manually selected by a user.

In one embodiment, the interface is a computer interface. In that way, a user friendly way is provided to allowing a user of the system to manually select the desired target luminance levels.

In one embodiment, the system further comprises occupancy sensors for detecting presence of a user for given areas within said space, where in case the occupancy sensors detect no presence in one or more areas selected from the areas the target illumination level at that given area is reduced.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows an embodiment of a method according to the present invention of controlling light distribution in a space including multiple installed light sources and an external light source,

FIG. 2 shows a block-diagram of one embodiment of how to implement the present invention in a space where the external light source is a daylight coming through a window and the internal light sources are light sources,

FIG. 3 shows a configuration of a single-user office space containing a window and four light sources,

FIG. 4 shows the performance of the proposed adaptive method for the office configuration example given in FIG. 3, and

FIG. 5 shows an embodiment of a system according to the present invention for controlling light distribution in a space including internal light sources and an external light source.

### DESCRIPTION OF EMBODIMENTS

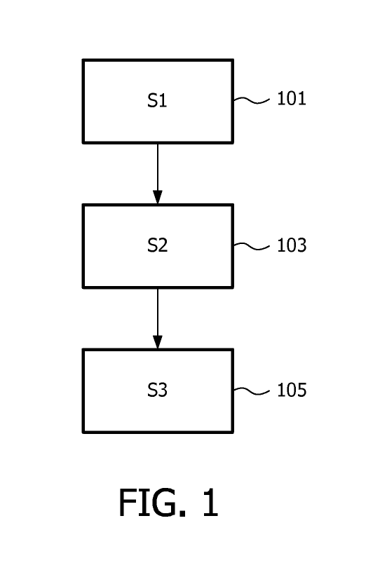

FIG. 1 shows an embodiment of a method according to the present invention of controlling light distribution in a space including multiple installed light sources and an external light source. The space can be as an example be a single office space, a large open office space, a part of a larger space, a living room etc.

In step (S1) 101, the luminance level of light from said light sources is measured at different measuring areas within the space, where the measuring area can e.g. be a point-like measuring area (e.g. at 20 difference places at the ceiling of the space) or a non-point like measuring area. The aim of measuring the light from said light sources at the multiple measuring areas is to obtain the light distribution within the space. Assuming the number of measuring areas is k and N is the number of installed light sources, the measured luminance level at each area, \vec{y}(n)=[y₁, . . . , yₖ]^{T} is assumed to have contributions from N installed internal light sources at the k areas, with light levels \vec{x}(n)=[x₁, . . . , xₖ]^{T} and from daylight luminance levels at the k areas, d\vec{l}(n)=[dl₁, . . . , dlₖ]^{T}, where n is a time indicator.

As an example, y₆ is the measured luminance level at measuring area nr. 6 and dl₆ is the contribution to the measured luminance level due to the external light source (e.g. a window), and x₂ is the actual light level at light source nr. 2.

In step (S2) 103, a weighed luminance level is determined for each of said measuring areas based on the measured luminance levels, where the weighted luminance level indicates the contribution from the light sources to the measured luminance level at said different measuring areas. Accordingly, if as an example the number of light sources is three, l1, l2 and l3, and the number of measuring areas is two, m1 and m2, the weighed luminance level at m1 is e.g. 0.7 from l1, 0.5 from l2 and 0.2 from l3. Assuming the light sources are identical, this would imply that l1 is the light source that is closest to m1, 1.2 is the second closest etc.

In one embodiment, the step of determining the weighed luminance level comprises calculating the difference between the pre-defined target luminance level at said different measuring areas and said measured luminance levels;

\vec{e}(n)=\vec{u}(n)−\vec{y}(n), (1)

where \vec{u}(n)=[u₁, . . . , uₖ]^{T} is the pre-defined target luminance level at k different measuring areas and the vector elements u₁, . . . uₖ indicate the target illumination level at the respective measuring areas. The vector elements u₁, . . . , uₖ can either have equal target values meaning that the target luminance level is the same everywhere within the space, or two or more of the vector elements u₁, . . . , uₖ are unequal target values meaning that the target illumination level is not the same everywhere.

Accordingly, equation (1) determines the difference between the target luminance level and the measured luminance level at each respective measuring area. Subsequently, the calculated difference \vec{e}(n) is multiplied with N×k weight factor matrix A, where N is the number of installed light sources and the elements aᵢⱼ of the weight factor matrix A indicate weight of the N installed light sources to the measured luminance level at the different measuring areas. The columns of the matrix (or the rows) indicate the contribution of the light sources within the space to the measured light. Referring to the example above, m1 could be considered as one column (or raw) where the first element is 0.7, the second element in the first column is 0.5 and the third element is 0.2. This will be discussed in more details later.

In step (S3) 105, the weighed luminance level is utilized as a tuning parameter for tuning the emitted light at the installed light sources such that the weighed luminance level at each of the different measuring areas substantially matches a pre-defined target luminance level at the different measuring areas.

In one embodiment, the step of tuning the emitted light at the installed light sources is performed by iteratively adjusting a tuning parameter \vec{x}(n) until:

\vec{x}(n)≈\vec{x}(n−1)+μA\vec{e}(n) (2)

is fulfilled, and \vec{x}(n−1) being the tuning parameter previous to \vec{x}(n) and μ being an adaptation step size indicator which is typically between 0 and 1. It should be noted that the pre-defined target luminance level vector \vec{u}(n)=[u₁, . . . , uₖ]^{T} has already been taken into account in the calculated difference \vec{e}(n) in equation (1).

What equation (2) does is actually to minimize the mean-squared error (difference) of the measured luminance levels at the measuring areas between two subsequent time points, where equation (2) is actually a simplification of:

$$x ( n ) \approx x ( n - 1 ) + μ \frac{\partial {‖ e ( n ) ‖}^{2}}{\partial x} . \qquad ( 3 )$$

This equation says that the gradient of the “error” or difference \vec{e}(n) multiplied by the adaptation step size indicator μ and added to the previous light setting x(n−1), i.e. is added to the previous tuning parameter, should be equal (or substantially equal) to the subsequent tuning parameter x(n). Accordingly, the light controlling at each respective light source is based on adaptively tuning the tuning parameter x(n) so that equation (3), i.e. equation (2), are fulfilled, namely so that convergence to a steady state is reached that minimized the mean squared error.

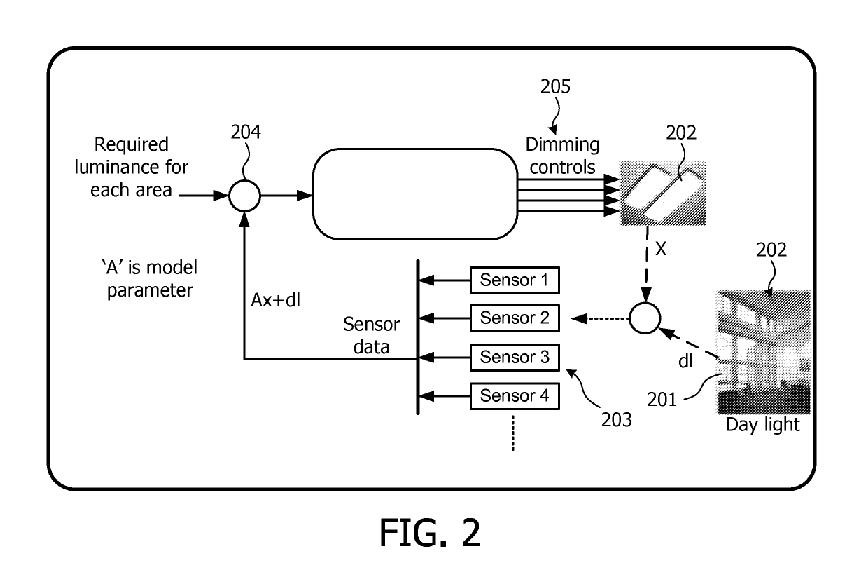

FIG. 2 shows a block-diagram of one embodiment of how to implement the present invention in a space where the external light source is a daylight coming through a window 201 and where the space includes internal light sources 202. The light luminance level is measured at different designated areas within the office using sensors 203. The aim of measuring the light from said light sources 201 and 202 using these multiple sensors 203 is to obtain the light distribution within the space. The measured luminance level at each sensor can be described using the following equation:

\vec{y}(n)=\vec{x}(n)+A+d\vec{l}(n), (4)

where \vec{x}(n), and d\vec{l}(n) and A have all previously been defined. At a first instant at the control unit 204 the difference between the measured weighted luminance levels and the pre-defined required luminance levels, selected by a user or users through a computer interface (not shown), for each area be determined using equation (1).

The difference between the weighted luminance for each area and the pre-defined target luminance level is utilized as a tuning parameter for tuning the emitted light at a second instant at the control unit 204 such that the weighed luminance level at each of the different measuring areas substantially matches a pre-defined target luminance level at the different measuring areas. The tuning is done using equation (2).

The tuning of the emitted light at the installed light sources is performed by iteratively adjusting a tuning parameter \vec{x}(n) until equation (2) reaches a steady-state value. These values are submitted to the dimming controls 205 controlling the light sources 202.

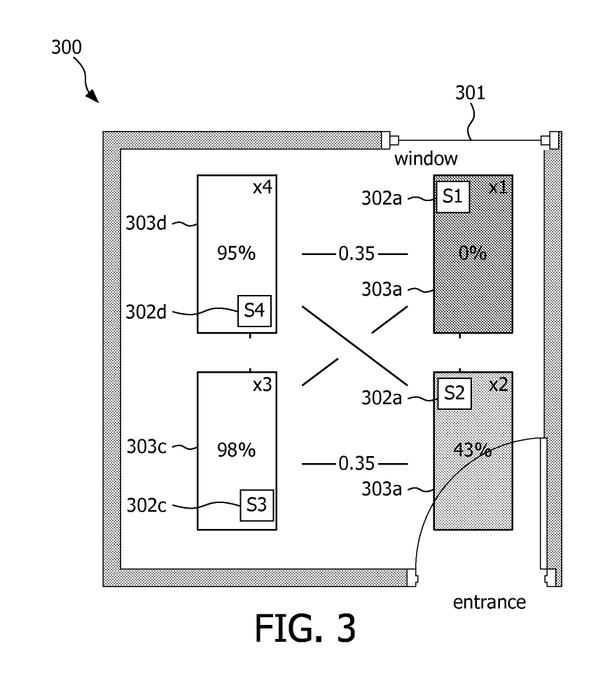

FIG. 3 shows a configuration of a single-user office space 300 containing a window and four light sources 303a-d. In this specific example the office is assumed to have a rectangular shape and being occupied by a single user. In the floor-view of the office the window 301 can be found in the upper corner which will create an unwanted non-uniform light distribution. In this example four sensors 302a-d, one under each light source 303a-d, are used to measure the luminance levels. It should be noted that the number of sensors does not have to be equal to the number of light sources. Also, the sensors do not necessarily be close or next to the light sources. The aim of implementing number of sensors is, as mentioned previously, to obtain the light distribution within the space. In this example, the normalized relationship matrix A is pre-decided from calibration measurements to be:

$$A = [ \begin{matrix}1.0 & 0.5 & 0.25 & 0.35 \\ 0.5 & 1.0 & 0.35 & 0.25 \\ 0.25 & 0.35 & 1.0 & 0.5 \\ 0.35 & 0.25 & 0.5 & 1.0\end{matrix} ]$$

These numbers describes how the different light sources are located in relation to the different sensors and therefore the contribution from each light source to the total luminance level measured at each sensor position. The maximum light from each light source 303a-d is normalized to 1. This means as an example that the first column corresponds to a first measuring area and indicates that 1.0 is the luminance level from a first light source (first line) which is closest to the measuring area (and is thus highest), 0.5 is the luminance level from a second light source (second line), 0.25 is the luminance level from the third light source (third line) etc. Similarly, the second column corresponds to a second measuring area and indicates that 0.5 is the luminance level from the first light source (first line), 1.0 is the luminance level from the second light source (second line) which is closest to the second measuring area etc. It should be noted that the column 1-4 could just as well be considered as the number of light sources and raw 1-4 be considered as the number of measuring areas.

Referring to equation (4), the measured luminance levels can be described by:

\vec{y}(n)=\vec{x}(n)A+d\vec{l}(n),

where the normalized luminance levels from the window at the measure points is assumed to be d\vec{l}=[1.5 1.0 0.5 0.5]^{T} (this is something that could be determined via a pre-calibration step of simply by estimating this in that way) and the normalized target luminance levels at each measure point may be set to \vec{u}=[2.1 2.1 2.1 2.1]^{T}. After the proposed adaptive method has been used a steady-state result is reached where the light source 303a next to the window 301 is turned off, the light source 303b next to the door is dimmed to 43% and the light sources 303c,d mounted in the areas being in the shadow are dimmed to almost full capacity reaching 95% and 98% respectively. This result exhibits about 40% reduction in lighting energy compared to if all light sources 303 were being used at full capacity.

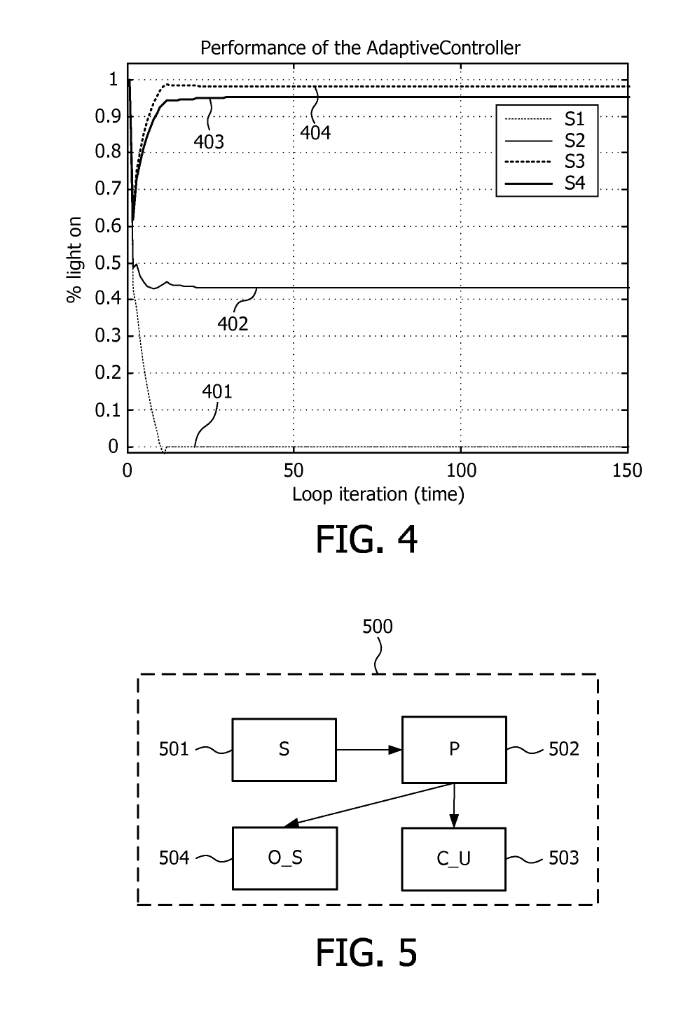

FIG. 4 shows the performance of the proposed adaptive method for the office configuration example given in FIG. 3. The graph shows the variation in the dimming output at each light source as a function of loop iteration or time from a initially state, where each light source was at turned on to 100%, until a steady-state was reached through successful use of the proposed adaptive method. Lines 401-404 are the percentage with light on for light sources 1-4 (s1-s4), respectively.

FIG. 5 shows an embodiment of a system 500 according to the present invention for controlling light distribution in a space including internal light sources and an external light source. The system comprises a sensor (S) 501, a processor (P) 502 and a control unit (C_U) 503.

The sensors can be any type of photo-sensors or photo-detectors, e.g. light emitting diode (LED) sensors, and/or photodiode and the like, and are adapted for measuring the luminance level of light from said light sources at different measuring areas within the space.

The processor (P) 502 is adapted to determine a weighed luminance level for each of said measuring areas based on the measured luminance levels, where the weighted luminance level indicates the contribution from the light sources to the measured luminance level at said different measuring areas.

The control unit (C_U) 503 may be a dimmer where e.g. one dimmer is associated to each light source (or two or more light sources) where the dimmer utilizes the weighed luminance level as a tuning parameter for tuning the emitted light at the installed light sources such that the weighed luminance level at each of the different measuring areas substantially matches a pre-defined target luminance level at the different measuring areas. As discussed in relation to FIG. 1, these weighed luminance levels are feed to the control unit, where the light levels in \vec{x} are the level of the dimming controls controlling the internal light sources. The control unit will also receive pre-defined target luminance levels, \vec{u}=[u₁, . . . , uₖ]^{T} for each dedicated area of the space. These target luminance levels may be manually set by the occupant or the occupants of the space in accordance to their needs. Each occupant of the space can manually set the luminance levels target of one or a plurality of areas within the space through a control interface for example a computer interface. The control unit or the processor will calculate the difference \vec{e}(n) between the pre-defined target luminance and the measures luminance levels at each area, \vec{e}(n)=\vec{u}(n)−\vec{y}(n). The control unit will perform an iteratively tuning by multiplying the calculated difference \vec{e}(n) with said N×k normalized weight factor matrix A, where the elements aᵢⱼ of the normalized weight factor matrix A being a number between 0 and 1 and indicates weight of the N installed light sources to the measured luminance level at the different measuring areas. The maximum light from each internal light source is therefore normalized to a maximum of 1. The normalized weight factor matrix A may be obtained through a calibration earlier calibration stage. This iteratively tuning will adjust the tuning parameter \vec{x}(n) until said equation:

\vec{x}(n)≈\vec{x}(n−1)+μA\vec{e}(n)

converges to a steady state, in most cases this occur when it reaches a value that minimizing the mean squared error. Parameter \vec{x}(n−1), in the above equation, being the tuning parameter previous to \vec{x}(n) and μ being an adaptation step size indicator. The tuning parameter \vec{x}(n) will then be used to set the new light levels of the internal light sources via dimming controls.

In one embodiment, the system 500 further comprises occupancy sensors (O_S) 504 for detecting presence of a user for given areas within said space, where in case the occupancy sensors detect no presence in one or more areas selected from the areas the target illumination level at that given area is reduced. For example, when an occupancy sensor does not detect presence for a given space, the system will reduce the target illumination level, i.e. the vector u for that given space to save more energy.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method of controlling light distribution in a space (300) including multiple installed light sources (303a-c) and an external light source (301), comprising:
measuring (101) the luminance level of light from said light sources at different measuring areas within the space,
determining (103) a weighed luminance level for each of said measuring areas based on the measured luminance levels, the weighted luminance level indicating the contribution from the light sources to the measured luminance level at said different measuring areas, and
utilizing the weighed luminance level as a tuning parameter for tuning (105) the emitted light at the installed light sources such that the weighed luminance level at each of the different measuring areas substantially matches a pre-defined target luminance level at the different measuring areas.

2. A method according to claim 1, wherein determining (103) the weighed luminance level comprises:
calculating the difference between the pre-defined target luminance level at said different measuring areas and said measured luminance levels;
\vec{e}(n)=\vec{u}(n)−\vec{y}(n),
where n is a time indicator, \vec{u}(n)=[u₁, . . . , uₖ]^{T} is the pre-defined target luminance level at k different measuring areas and the vector elements u₁, . . . , uₖ indicate the target illumination level at the respective measuring areas and where \vec{y}(n)=[y₁, . . . , yₖ]^{T} is the measured luminance level at the k different measuring areas, and
multiplying the calculated difference \vec{e}(n) with N×k weight factor matrix A with N being the number of installed light sources, where the elements aᵢⱼ of the weight factor matrix A indicates weight of the N installed light sources to the measured luminance level at the different measuring areas.

3. A method according to claim 2, wherein the step of tuning (105) the emitted light at the installed light sources is performed by iteratively adjusting tuning parameters \vec{x}(n) until:
\vec{x}(n)≈\vec{x}(n−1)+μA\vec{e}(n)
is fulfilled, \vec{x}(n) being length N column vector, \vec{x}(n−1) being the tuning parameters previous to \vec{x}(n) and μ being an adaptation step size indicator.

4. A method according to claim 2, wherein the vector elements uᵢ, . . . , uₖ are equal target values.

5. A method according to claim 2, wherein the two or more of the vector elements uᵢ, . . . , uₖ are unequal target values.

6. A method according to claim 2, wherein the weight factor matrix A is a normalized matrix such that the weight factor matrix elements aᵢⱼ of the weight factor matrix are assigned a weight value between 0 and 1.

7. A method according to claim 1, further comprising detecting presence of a user for given areas within said space, where in case no presence is detected within a given area selected from the areas that the target illumination level at that given area is reduced.

8. A computer program product for instructing a processing unit to execute the method step of claim 1 when the product is run on a computer.

9. A system (500) for controlling light distribution in a space (300) including internal light sources (303a-d) and an external light source 301, comprising:
sensors (501) for measuring the luminance level of light from said light sources at different measuring areas within the space,
a processor (502) for determining a weighed luminance level for each of said measuring areas based on the measured luminance levels, the weighted luminance level indicating the contribution from the light sources to the measured luminance level at said different measuring areas,
a control unit (503, 302a-d) for utilizing the weighed luminance level as a tuning parameter for tuning the emitted light at the installed light sources such that the weighed luminance level at each of the different measuring areas substantially matches a pre-defined target luminance level at the different measuring areas.

10. A system according to claim 9, wherein the interface is a computer interface.

11. A system according to claim 9, further comprising occupancy sensors (504) for detecting presence of a user for given areas within said space, where in case the occupancy sensors detect no presence in one or more areas selected from the areas the target illumination level at that given area is reduced.
